(19) United States
(12) Patent Application Publication
(10) Pub. No.: US 2004/0128237 A1
(43) Pub. Date: Jul. 1, 2004

(54) Code driven customization for a prepaid account

(76) Inventor: Oye Obe, New Rochelle, NY (US)

Correspondence Address: Oye Obe, 815 Serramonte Drive, Marietta, GA, 30068, US

(21) Appl. No.: 10/335,570

(22) Filed: Dec. 30, 2002

(51) Int. Cl. G06F 17/60

(52) U.S. Cl. 705/39

(57) ABSTRACT

A suite of prepaid card products consisting of prepaid cards cross-matched against labels imprinted with customization codes (CC). At the point of purchase of a prepaid card, the user is provided with one or more labels, each imprinted with one or more CC's, each CC being applicable to the purchased prepaid card account for the purpose of customizing the features & behavior of the prepaid account. The prepaid system comprises of a system center (host computer network) including an accounts database containing prepaid accounts, a customizing database containing specifications for the CC's, and a default database containing default values for customizable parameters. The user connects to the system center by dialing an access number, the system center prompts the user to enter a personal identification number (PIN), and the system center receives and determines if the PIN is valid. If the system center determines that the PIN is valid, the system center prompts to ask if the user wishes to enter a CC for the prepaid account. If so, the system center prompts the user to enter the CC, the system center validates the CC and records the selection in the accounts database. Subsequently, the behavior of the prepaid account with respect to fees, rates as well as other customizable features is subject to the CC's entered for the prepaid account.

### BACKGROUND OF INVENTION

Remote-memory prepaid accounts are widely used for buying goods and services. In its most common form, a prepaid account includes a unique personal identification number (PIN) associating it with a wallet-size card imprinted with the PIN. The card is typically made of a printable substrate such as paper, paperboard or plastic, and may also be imprinted with instructions for accessing goods, services and other features of the prepaid account. A layer of scratch-off paint or other coating may be sprayed or applied by other means onto the card to temporarily conceal the PIN. Remote-memory prepaid account records are stored remotely on a system center (host computer network) and typically comprise such information as the current prepaid account balance in addition to the unique PIN.

The use of remote-memory prepaid phone cards for making long-distance telephone calls is particularly well known. Usually, the prepaid card provider maintains a toll free or local access phone number answered by a system center with associated telephone equipment including a telephone switch suitable for connecting a calling party to a destination number. The prepaid phone card is typically imprinted with the PIN, the access number and instructions for card-users to follow in order to place calls. The system center answers calls to the access number, and provides audio instructions prompting the card-user to enter a PIN. The system center validates the PIN and the current cash or time value associated with the prepaid phone account. Next, the card-user enters a destination party number and the system center connects the card-user to the destination party number, thereby placing the telephone call for the card-user. As a result, the prepaid account balance is reduced by the amount charged to the call.

Prepaid phone cards are often issued to promote sales to consumers whose calling needs are focused on a specific geographical location. These cards typically advertise low rates and fees for calls to a specified continent, country, state, province or city. However, these value-adding features are built into the card and do not offer the card-user the opportunity to select a package or combination of features best suited to their calling needs.

Also, it would be advantageous to have a method for promoting sales that eliminates or reduces the need to issue additional prepaid cards, by offering add-on customizations such as reduced rates, no connection fee and other value-adding features for existing cards.

Further, the wide range of card-user needs are not well served by current mechanisms that provide audio instructions after the card-user connects to the system center, on how to apply optional features such as selecting a language or transferring the cards balance to another card.

A system and method is thus needed to overcome the limitations of the prior art.

### SUMMARY OF INVENTION

Each prepaid card in this mechanism is classified by a suite-card-type and each label is classified by a label-type. The card-issuer develops a product suite by cross-matching suite-card-types and label-types. Variety and features in the product suite derive from the matching associations established between the suite-card-types and label-types. Hence, the range of prepaid card options offered by this mechanism allows substantial flexibility for providing card-users with service best tailored to their needs.

According to the invention, the card-user receives a prepaid card in conjunction with one or more add-on customizing labels at the point of purchase, all of said labels having a matching association with the prepaid card. The type of prepaid card and labels provided to the card-user depend on the geographical location/s the card-user intends to make calls to, the card-users calling preferences and other factors. This mechanism involves the use of customization codes (CC), one or more of which are imprinted on a customizing label. The card-user establishes an authenticated connection to the system center by dialing an access number and entering a valid PIN. As a result, the CC's currently in effect are automatically imposed on further activity associated with the prepaid card account. Subsequently, the card-user has the ability to add CC's to the prepaid account, remove CC's from the prepaid account or to perform supported transactions such as completing long-distance calls.

As a result, a prepaid card provider can develop an enhanced level of variety and features in its product line by issuing suites consisting of prepaid cards and labels, offered to consumers in ensembles each comprising a prepaid card and one or more matching labels. This mechanism provides more comprehensive coverage for the prepaid needs of targeted consumers than is available from existing prepaid systems, hence promoting sales of prepaid cards.

Also, significant cost and productivity savings are achieved by producing new labels rather than the more expensive new cards, in order to introduce new promotions and features. New labels can also reduce the need to recall and replace retired cards. Older prepaid cards still in circulation can continue to be sold by issuing new labels that match older and newer cards alike, in effect “grand-fathering” the older cards. On the other hand, retired labels can simply be disposed of.

From the consumer perspective, this invention represents a convenient “booster-card/sticker” add-on, providing selectable features and added-value tailored to the card-users individual needs.

In another aspect, one or more CC's are comprised on a prepaid card, to provide similar benefits to the use of labels.

### BRIEF DESCRIPTION OF DRAWINGS

FIG. 1A is a view of one side of an exemplary prepaid card according to the invention.

FIG. 1B is view of the reverse side of the prepaid card of FIG. 1A.

FIG. 2A is a view of one side of an exemplary label according to the invention.

FIG. 2B is a view of the reverse side of the label of FIG. 2A.

FIG. 2C is a view of the label affixed to the prepaid card according to the invention.

FIG. 3 is a schematic diagram of an exemplary system center according to the invention.

FIG. 4 is a matrix chart of cross-matching suite-card-types and label-types according to the invention.

FIG. 5 is a representation of data records stored in the system center according to the invention.

FIG. 6 is a flowchart showing an exemplary sequence for customizing and using a prepaid account according to the invention.

FIG. 7 is a view of the reverse side of the label of FIG. 1A in an alternate embodiment according to the invention.

### DETAILED DESCRIPTION

The preferred exemplary embodiment below and in the accompanying drawings surrounds a remote-memory prepaid telephone card. However, the invention contemplates virtually any type of transaction card instrument or methodology for virtually any type of goods or services of whatever kind or nature.

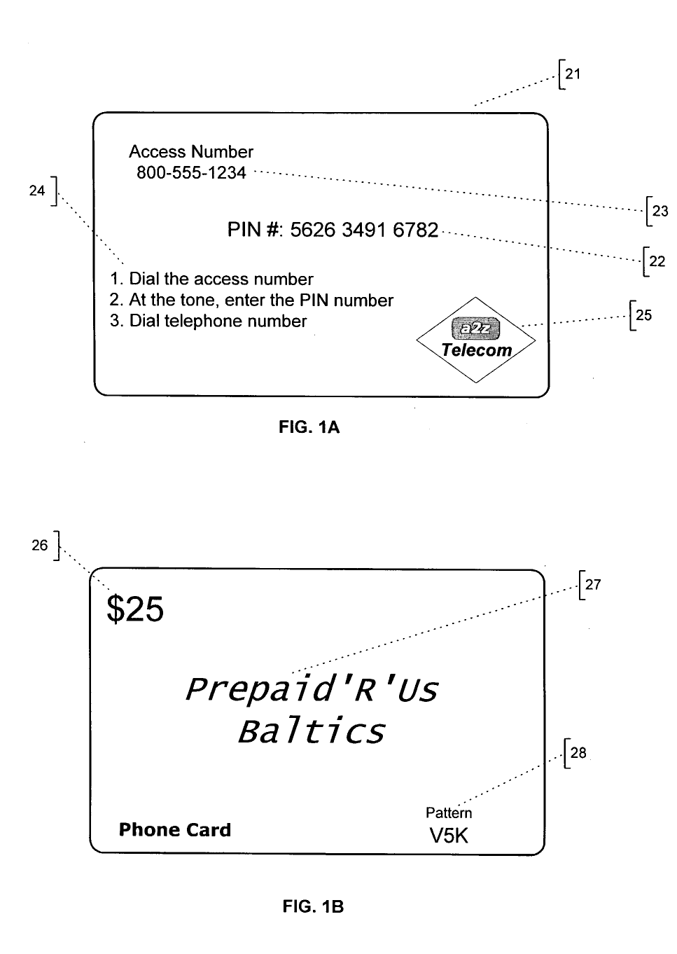

Referring now to FIG. 1A, an exemplary prepaid card 21 is analogous in its physical embodiment to a credit card-like instrument, being comprised here of printable paper substrate. In a preferred embodiment, card 21 is 8.6 cm in length, 5.4 cm broad, and has a thickness of 0.75 mm. With continued reference to FIG. 1A, prepaid card 21 comprises an access telephone number 23 for accessing a prepaid service provider's system center and a personal identification number (PIN) 22 for accessing the cards associated prepaid account. Access telephone number 23 may be a toll-free 800 number or a local phone number. PIN 22 is a numeric or alphanumeric code preferably unique to a particular telephone card.

With continued reference to FIG. 1A, instructions 24 may be set forth on card 21 explaining how to place phone calls through the system center. Additional information, drawings, photographs, letters or designs 25 may be suitably printed on card 21.

Referring now to FIG. 1B, the opposite side of prepaid card 21 comprises a visual indicia 27, which may include drawings, photographs, letters or other designs. A number 26 may be printed on prepaid card 21 to indicate the value or initial balance amount associated with prepaid card 21. This amount may be in currency or may be in card units. Usage of card 21 reduces the balance in the account by the telephone charges incurred. This side also comprises a card-matching-pattern (CMP) indicia 28 that determines which labels can be applied to the prepaid card.

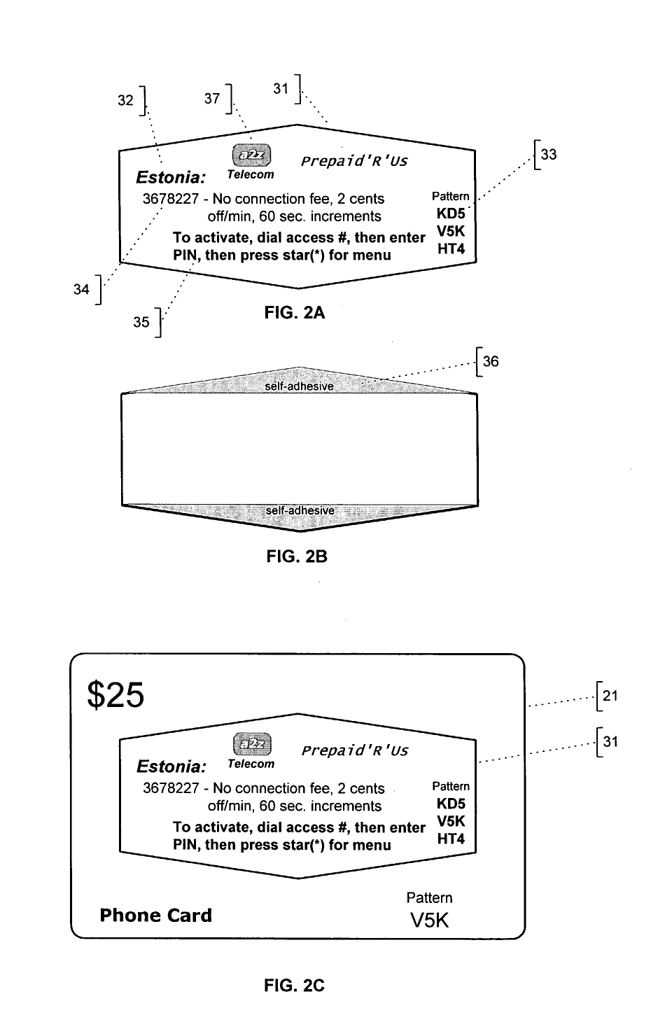

Referring now to FIG. 2A, a label comprised here of printable paper material. In a preferred embodiment, label 31 is sized to be affixable to prepaid card 21. Destination 32 specifies the calling destination the label 31 is issued for. Label 31 also comprises a customization code (CC) 34 and its description. In another embodiment, a removable opaque layer of scratch-off paint or other coating may temporarily conceal indicia for customization codes (CC) 34 issued for distribution on a limited basis or for other security or process related purposes.

Each CC is associated with one or more customization criteria: For example, a CC might be associated with one or more of the following exemplary customization criteria:

1. reduce rate by “X” cents (or by “X” %) for billing calls to specified location, in specified time-period

2. allow call-origination from a specified geographical location

3. waive or reduce specified fee (connection, maintenance, pay-phone, per-call . . . )

4. reduce billing-increment period

5. set fixed rate to “X” cents for billing calls to specified destination, in specified time-period

6. set “clean” card option (removes most or all fees)

With continued reference to FIG. 2A, Label 31 also comprises a label-matching-pattern (LMP) indicia 33 that determines which prepaid cards the label is applicable to.

Additional information, drawings, photographs, letters, or designs 37 may be suitably printed on label 31. Instructions for using the label may also be provided as in 35. Information 35 and 37 may include trademarks or service marks of the issuer or information for advertising various related or unrelated products or virtually any additional information or data may be set forth on label 31.

Referring now to FIG. 2B, the reverse side of the label has a self-adhesive layer 36 positioned thereon that affixes it to a prepaid card. In another embodiment, the prepaid card and its associated labels may be inserted into a wallet size envelope printed with instructions and other information. In yet another embodiment, the label may be affixed to packaging containing the prepaid card.

This embodiment illustrates a prepaid device comprising a prepaid card and a single label wherein said label has one customization code (CC). It will be apparent however to those skilled in the art, upon viewing the specifications and drawings, that various modifications and variations can be made without departing from the scope or spirit of the invention.

Referring now to FIG. 2C, label 31 is affixed to matching prepaid card 21 by self-adhesive 36. The match is made by the common matching code “V5K” composed into the CMP and LMP patterns of prepaid card 21 and label 31 respectively.

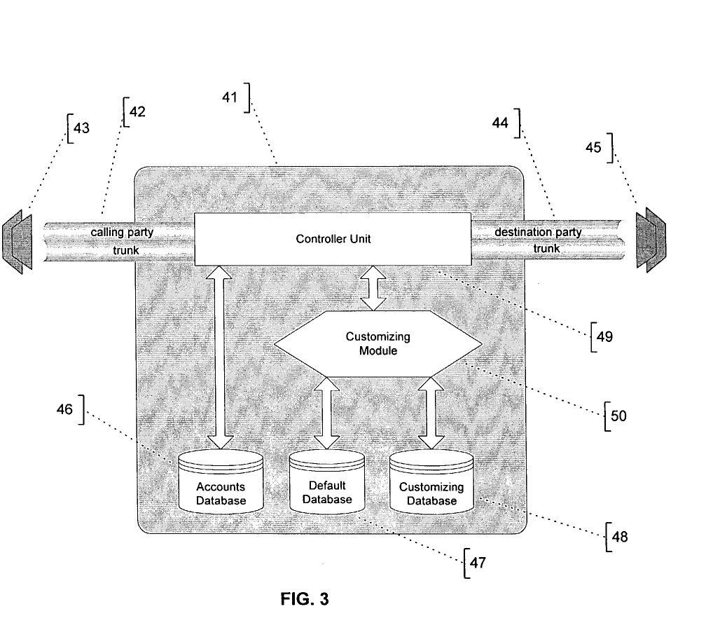

Referring now to FIG. 3, a system center (host computer network) 41 for use with prepaid card 21 comprises an accounts database 46, a default database 47 containing the default values that apply to the prepaid card 21 in the absence of customization and a customizing database 48 storing specifications for the customization codes. Databases 48, 47 and 48 may be included in a single database structure or may be separate, individual databases. The system center 41 also provides various functions including call switching, call routing, call record creation, call processing, and management and control of the various accounts associated with prepaid calling.

With continued reference to FIG. 3, system center 41 suitably comprises an incoming call trunk 42, a controller unit 49, a customizing module 50, associated memory means such as random access memory (RAM), a tape drive, a magnetic drive, a compact disc, or the like. Trunk 42 represents just one of multiple incoming telephone lines grouped to serve the same access telephone number. When a card-user places a call from a calling station such as a telephone 43, card-user is connected to system center 41. Controller unit 49 then routes the call through communications trunk 44 to called station 45. Controller unit 49 also monitors the call connection. The customizing module 50 manages the flow and processing of data to and from default database 47 and customizing database 48.

In accordance with the present invention, a prepaid service provider or telephone company or other entity issuing telephone card 21 may suitably perform the functions of system center 41. Those skilled in the art will appreciate that system center 41 includes suitable computing hardware and software for effecting the functions set forth herein.

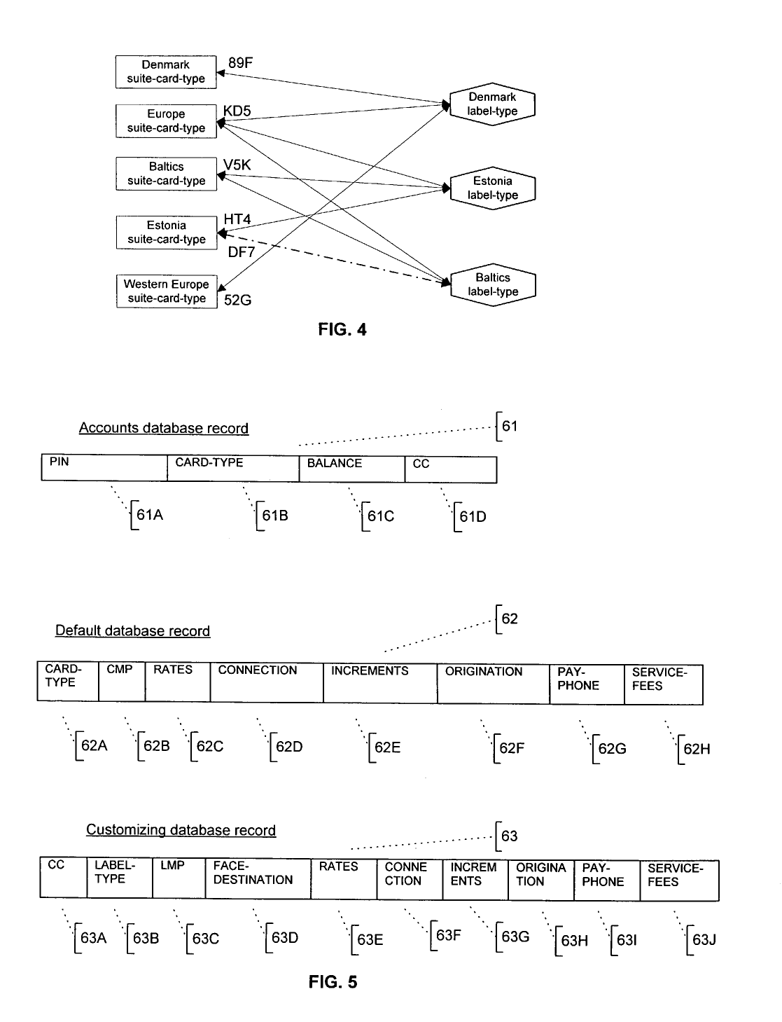

Referring now to FIG. 4, a prepaid service provider develops an exemplary cross-matching matrix comprising five suite-card-types and three label-types graphically represented by the chart shown thereon.

The suite-card-types represent prepaid cards issued for calls to “Europe”, “Western Europe”, “The Baltics”, “Estonia” and “Denmark” while the label-types represent labels with customizations for Denmark, Estonia and the Baltic States (Estonia, Latvia and Lithuania).

Next, the prepaid service provider assigns a primary matching code for each of the suite-card-types in the suite. Note that matching codes are alphanumeric and unique within the suite. Also, additional matching codes may be assigned to account for special relationships. For instance, a special matching code “DF7” is assigned to establish a relationship between the Estonia suite-card-type and the Baltics label-type, making the matching code available for future suite-card-types targeting Lithuania and Latvia, the other two Baltic countries. Additional special matching codes may also be assigned for other purposes such as matches for limited-time promotions, matches “grand-fathered” for older suite-card-types, matches that are limited to the use of a specific type of customization . . . etc.

The matching codes corresponding to each suite-card-type are accumulated in any order to generate a card-matching-pattern (CMP). Hence the Estonia suite-card-type's CMP might comprise “HT4 DF7”. To generate a label-matching-pattern (LMP), the associated matching code from each matching suite-card-type is likewise accumulated in any order into the LMP of the label-type. Hence the Denmark label-types LMP might be composed as “89F KD5 52G”.

As a result, a distribution agent or retail agent is able to quickly and accurately make the predetermined matches needed to provide a customer with an ensemble comprising one prepaid card and one or more matching labels. Comparing the CMP indicia on the prepaid cards with the LMP indicia on the labels reveals the common matching code/s in both patterns. The presence of at least one common matching code in both the CMP and LMP constitutes a match. For example a CMP composed on a prepaid card as “xxx yyy” would constitute a match with an LMP composed on a label as “qqq yyy zzz” due to the presence of common matching code “yyy” in both patterns.

Referring now to FIG. 5, in accordance with the preferred embodiment, the data associated with prepaid card 21, customizing label 31 and the matching matrix of FIG. 4 is reduced into databases 46, 47 and 48 whereby:

1) PIN data is represented as database record 61 of accounts database 46

2) suite-card-type data is represented as database record 62 of default database 47

3) label-type CC data is represented as database record 63 of customizing database 48

To determine the customizations in effect for a PIN account, the system center fetches the PIN record 61 from the accounts database 46 using the entered PIN 22 as key. If the PIN record contains a value for CC 61D, CARD-TYPE 61B is extracted from the PIN record, otherwise no customization is applied. Next the system center fetches the corresponding CARD-TYPE record 62 from default database 47 using the extracted CARD-TYPE 61B as key. To determine the customization in effect for the PIN, the system center fetches the CC record 63 corresponding to CC value 61D and applies the customization fields 63E-63J in CC record 63 to the corresponding default fields 62C-62H in the CARD-TYPE record 62. The application of customized parameters to default parameters typically entails substitution of custom over default values, addition, subtraction, multiplication or some other mathematical function depending on the nature of customization intended.

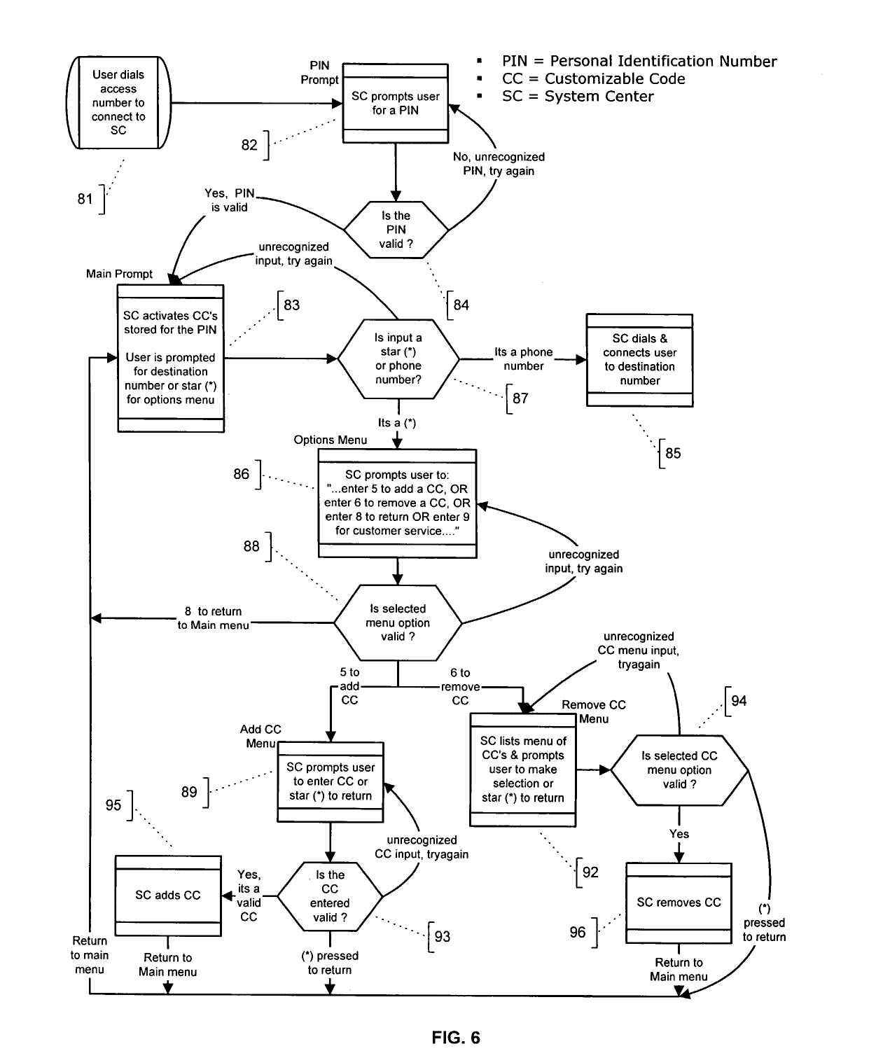

Referring now specifically to the flowchart of FIG. 6 and with references to FIGS. 1-5 described above, an exemplary method for customizing a prepaid account in the context of a prepaid phone card system will be explained. A preferred embodiment comprises the following methodology implemented by a computer readable program code that is stored in a computer usable medium such as memory and executed by controller unit 49.

The card-user in possession of calling card 21 uses calling station 43 to dial access number 23. After card-user from calling station 43 connects to system center 41 as shown at block 81, the system center, at block 82, prompts the card-user for PIN 22. This prompt may be a tone that the card-user recognizes as a prompt for PIN 22, or audio instructions instructing the card-user to input PIN 22.

With continued reference to FIG. 6, upon receipt of PIN 22, system center 41, at block 84, accesses accounts database 46 to determine if PIN 22 is valid (i.e. the PIN is checked to confirm that such a number exists and that there is money or credit units remaining in the account). If PIN 22 is not valid as shown at block 84, system center 41 informs the card-user that PIN 22 is invalid and requests another PIN at block 82. If the PIN is determined to be valid, system center goes to Main Menu block 83 and accesses database 46 to fetch the CC's currently entered into the prepaid card account. Hence, PIN 22 is used as key to access database 46 in order to fetch the CC's. Then system center 41 activates the CC's and prompts the card-user to enter a destination phone number or a star (“★”) for the options menu.

If the card-user enters a star (“★”), system center 41 goes to the options menu block 86 and prompts the card-user, to enter a choice. In the exemplary embodiment, the options menu provides various choices such as a customer service option for connecting to customer service, CC options for adding or removing CC's from the prepaid account and other options or submenus as deemed appropriate or relating to placing long distance telephone calls.

If the card-user chooses to add a CC, system center 41 prompts the card-user at 89 to enter the CC. The CC is validated at block 93. At block 95, system center 41 records the CC input in field 61D in database 46, hence any subsequent customizable activity on the prepaid account is subjected to the CC.

If the card-user chooses to remove a CC, system center 41 presents to the card-user a menu 92 of customization codes contained in the prepaid account for PIN 22. When the menu of CC's is reported to the card-user, each CC is recited to the card-user along with a corresponding number that the card-user is to input from telephone 43 to remove that CC. Block 96 subsequently removes the CC from field 61D after validation at block 94.

Next, system center 41 proceeds from block 95 or block 96 back to block 83, where the card-user is prompted to enter a destination phone number or a star (“★”) for the options menu. At block 87, the system center 41 determines whether the input is a star or a valid destination phone number. If it is neither, system center returns to block 83 and again prompts the card-user for a destination phone number or a star (“★”). If the card-user enters a valid destination phone number, system center 41 goes to block 85 where it connects the card-user to communications link 44 and dials the destination phone number.

In another embodiment, instead of proceeding to block 83, the system center would proceed from blocks 95 and 96 to blocks 89 and 92 respectively.

While FIG. 6 shows the present invention as incorporated with a prepaid calling card system, it is important to remember that the present invention contemplates systems that use other types of transaction cards. The embodiment shown in FIG. 6 should not be interpreted as being limited to prepaid telephone cards.

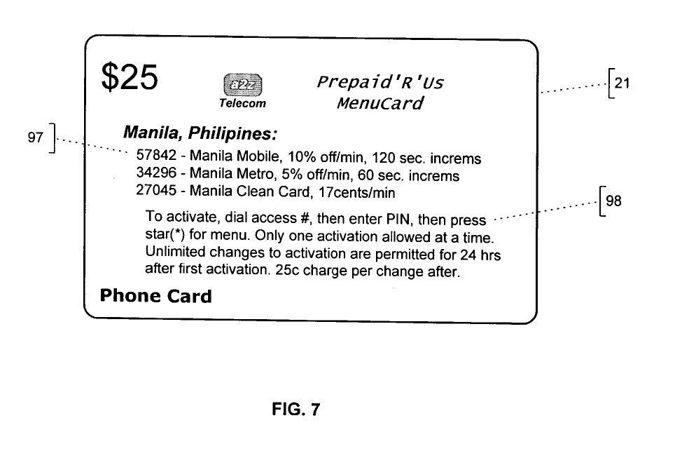

Referring now to FIG. 7, in a “Menu-Card” embodiment, one or more CC's are imprinted on the prepaid card. Indicia 97 comprises one or more CC's issued for the prepaid card. The prepaid card is further comprised with instructions 98. In accordance with this embodiment, the system center would include an additional database, the modifications database. This database tracks modifications to the set of CC's including entries of CC's and removals of CC's. The data stored for each modification includes the PIN, the type of modification and the time of modification, enabling the system center to determine conditions for restricting modifications to the set of CC's entered for the prepaid account.

The invention set forth herein in the context of the appended drawing figures is not limited to the specific forms shown. Various other modifications, variations, and enhancements in the design and arrangement of the suite, system center and the like as set forth herein may be made without departing from the spirit and scope of the present invention as set forth in the appended claims.

What is claimed is:

1) A suite of prepaid card products comprising:
a. one or more prepaid cards and one or more suite-card-types;
wherein each prepaid card can be classified by a parent suite-card-type;
wherein each suite-card-type possesses a card-matching-pattern (CMP) attribute comprising alphanumeric codes, or symbols, or letters or a combination of any of the above; and
wherein each prepaid card is imprinted with said CMP indicia, inherited from its parent suite-card-type.
b. one or more labels and one or more label-types;
wherein each label can be classified by a parent label-type;
wherein each label-type possesses a label-matching-pattern (LMP) attribute comprising alphanumeric codes, or symbols, or letters or a combination of any of the above;
wherein each label is imprinted with said LMP indicia, inherited from its parent label-type;
wherein each label further comprises enterable indicia provided for entry into a prepaid system; and
wherein each label is made of printable substrate such as paper or plastic.
c. a means for establishing a cross-matching relationship between said suite-card-types and said label-types by composing the contents of said CMP patterns and said LMP patterns to reflect the desired cross-matches.
d. a means for creating one or more prepaid devices from the cross-matching relationships composed into said CMP and said LMP patterns, wherein each device comprises a prepaid card and one or more matching labels.

2) The suite of claim 1, wherein said label further comprises descriptions for said enterable indicia.

3) The suite of claim 1, wherein said label further comprises instructions for entering said enterable indicia into said prepaid system.

4) The suite of claim 1, wherein said label is affixable to said prepaid card.

5) The suite of claim 1, wherein said label is affixable to packaging containing said prepaid card.

6) A method for entering selections used by a system center for customizing the features and behavior of a prepaid account, comprising the steps of:
a. providing a card-user with a prepaid device comprising a prepaid card and one or more customization codes (CC) which can be entered by the card-user into said system center;
b. connecting the card-user to the system center;
c. entering of the PIN for a prepaid account by the card-user;
d. receiving said PIN from the card-user by the system center, and determining if said PIN represents a valid prepaid account;
e. after validation of said PIN, all further customizable activity is subjected by the system center to the CC's currently entered for said prepaid account;
f. entering of a CC by the card-user into the system center;
g. receiving and addition of said CC by system center;
h. prompting the card-user for a destination telephone number;
i. connecting the card-user to the destination telephone number; and
j. reducing the balance in said prepaid account by the amount charged to the call.

7) The method of claim 6, wherein said step of providing a card-user with a prepaid device further comprises providing the card-user with one or more labels imprinted with said CC's.

8) The method of claim 7,
wherein said prepaid card and said label further comprise pattern indicia for establishing a match between said prepaid card and said label; and
wherein said pattern indicia comprises alphanumeric codes, or symbols, or letters or a combination of any of the above.

9) A method as recited in claim 8, wherein (f) and (g) are practiced by
entering by the card-user of a removal number corresponding to a CC to be removed from the system center; and
receiving of said removal number and removal of CC corresponding to said removal number by the system center.

10) The method of claim 8, wherein said label is imprinted with descriptions for said CC's.

11) The method of claim 8, wherein said label is imprinted with instructions on how to enter said CC's into the system center.

12) The method of claim 8, wherein said label is affixable to said prepaid card.

13) The method of claim 8, wherein said label is affixable to packaging containing said prepaid card.

14) The method of claim 8, wherein one or more of the CC's imprinted on said label are concealed by user removable strips.

15) The method of claim 8, wherein the system center comprises a means for restricting the entry of modifications to the set of CC's entered for said prepaid account.

16) The method of claim 8, wherein the system center charges a fee to said prepaid account for modifications to the set of CC's entered for said prepaid account, made after a specified period of time following a specified action by the card-user.

17) The method of claim 6, wherein packaging for said prepaid card is imprinted with said CC's.

18) A method as recited in claim 6,
wherein (a) is practiced by providing the card-user with said prepaid account PIN and said CC's by email, or by web-interface, or by other suitable electronic media; and
wherein said CC's can be entered by the card-user into said system center.

19) The method of claim 6, wherein said prepaid card is imprinted with said CC's.

20) The method of claim 19, wherein said prepaid card is imprinted with descriptions for said CC's.

21) The method of claim 19, wherein said prepaid card is imprinted with instructions on how to enter said CC's into the system center.

22) The method of claim 19, wherein one or more of the CC's imprinted on said prepaid card are concealed by user removable strips.

23) The method of claim 19, wherein the system center comprises a means for restricting the entry of modifications to the set of CC's entered for said prepaid account.

24) The method of claim 19, wherein the system center charges a fee to said prepaid account for modifications to the set of CC's entered for said prepaid account, made after a specified period of time following a specified action by the card-user.

25) The method of claim 7, wherein said prepaid card and said label are comprised with alphanumeric codes, or symbols, or letters, or graphics, or other designs, or a combination of any of the above to indicate a common issuer or source, thereby indicating that said CC's on said label can be entered for said prepaid card.
